(19) United States
(12) Patent Application Publication
(10) Pub. No.: US 2026/0147473 A1
(43) Pub. Date: May 28, 2026

(54) METHODS AND DEVICES FOR VIRTUAL KEYBOARD CUSTOMIZATION

(71) Applicant: Huawei Technologies Co., Ltd., Shenzhen (CN)

(72) Inventors: Yu Zhao, Kanata (CA); Yuan Deng, Kanata (CA); Soumil Chugh, Kanata (CA); Che Yan, Toronto (CA); Wei Li, Markham (CA)

(21) Appl. No.: 18/962,770

(22) Filed: Nov. 27, 2024

(51) Int. Cl. G06F 3/04886; A63F 13/22; G06F 3/0486; G06T 7/90; G06T 11/00

(52) U.S. Cl. CPC G06F 3/04886; A63F 13/22; G06F 3/0486; G06T 7/90; G06T 11/10; G06T 2200/24; G06T 2207/10024

(57) ABSTRACT

Methods and devices to customize a virtual keyboard on a touchscreen display. A request or other trigger event may be associated with an image that has one or more dominant colours. A set of colours is determined within colour space by varying the coordinates of the dominant colour(s) in one or more dimensions. Each colour in the set of colours is applied to one or more keys of the virtual keyboard. The colours may produce a gradient effect. The dominant colour may be determined based on object recognition and segmentation. Multiple objects may be identified and used to determine the set of colours and their relative spatial relationship may be reflected in how the colours are mapped to the virtual keyboard.

### FIELD

The present application relates to customization of virtual keyboards on touch-screen devices.

### BACKGROUND

Touchscreens are becoming ubiquitous in computing devices with the proliferation of smartphones, tablets, and laptop computing devices. Foldable screens are being used in new laptop configurations that feature double screens and no physical keyboard. With all the new form factors for touch-sensitive devices, virtual keyboards are becoming more common in these computing devices.

One of the drawbacks of a virtual keyboard is the lack of physical feedback to enable touch typing. Accordingly, many virtual keyboards feature custom colour schemes, key press sound effects, and/or key press animations that help provide visual and auditory feedback to users. Aside from aesthetic considerations, distinctive colouring of keys in a virtual keyboard can assist a user in determining a ‘home’ position for touch typing and for improving the accuracy of keyboard input.

Customization of a virtual keyboard theme may be challenging for less computer-savvy users, since it typically involves navigating to a deep settings menu, selecting and specifying particular key colours and otherwise setting configuration parameters that may be unfamiliar to users. This may result in substandard key differentiation and consequently poor accuracy of keyboard input.

### BRIEF SUMMARY

In accordance with one aspect, the present application describes a method of customizing a virtual keyboard on a computing device having a touchscreen. The method may include detecting a virtual keyboard customization trigger associated with an image; identifying, in a colour space, at least one dominant colour within the image; determining a plurality of colours associated with the at least one dominant colour based on coordinates of the at least one dominant colour within the colour space through varying one or more dimensions of the coordinates within the colour space; applying each of the plurality of colours to one or more respective keys of the virtual keyboard to generate a customized virtual keyboard; and rendering the customized virtual keyboard on the touchscreen.

In some implementations, varying one or more dimensions includes varying a dimension of the coordinates over a range, and applying includes mapping the range of the dimension of the colour space to a dimension of the virtual keyboard. In some cases, applying includes applying each of the plurality of colours to the one or more respective keys based on a position of that colour in the range being mapped to a corresponding position on a vertical or horizontal dimension of the virtual keyboard.

In some implementations, detecting the virtual keyboard customization trigger includes detecting a drag-and-drop operation selecting the image and positioning at least a portion of the image atop the virtual keyboard. In some cases, the detecting the drag-and-drop operation includes applying object segmentation to identify an object in the image, and the identifying at least one dominant colour includes identifying the at least one dominant colour as a dominant colour within the object in the image.

The drag-and-drop operation may include detecting selection and positioning of the object atop the virtual keyboard.

In some implementations, identifying at least one dominant colour includes identifying a background dominant colour from the image excluding the object, and applying may include applying the background dominant colour to a background region of the virtual keyboard surrounding the one or more respective keys of the virtual keyboard.

In some implementations, identifying at least one dominant colour includes segmenting the image to identify an object of the image and identifying the at least one dominant colour within the object. Segmenting may include identifying two or more objects and identifying a dominant colour associated with each of the two or more objects, and determining the plurality of colours may include determining coordinates of each of the dominant colours and identifying the plurality of colours based on a gradient of colours that includes at least each of the dominant colours.

In some cases, the two or more objects are horizontally and vertically positioned relative to each other in the image, and applying the plurality of colours may include mapping the plurality of colours to the one or more respective keys using a mapping based on the horizontal and vertical positioning of the two or more objects within the image.

In some implementations, varying the one or more dimensions of the coordinates within the colour space includes varying one or more colour parameters of the dominant colour, wherein the colour parameters include one or more of hue, saturation, and brightness.

In another aspect, the present application describes a method of customizing a virtual keyboard on a computing device having a touchscreen. The method may include detecting a virtual keyboard customization trigger associated with a media item, wherein the media item has a media type selected from an image, text, or audio; determining one or more characteristics of the media item; mapping the one or more characteristics of the media item to at least one virtual keyboard feature in a different media type from the media item, wherein the virtual keyboard feature is one of a virtual keyboard colour, a key press sound effect, or a key press animation; and applying the at least one virtual keyboard feature to a displayed virtual keyboard on the touchscreen.

In some implementations, the media type of the media item is the text or the audio, and the audio is speech input, and mapping includes converting the text or speech input to an image and selecting the virtual keyboard colour based on the image.

In some implementations, the media type of the media item is the image and wherein determining includes performing object recognition within the image to identify an object, and mapping includes selecting the key press sound effect based on the object.

In some implementations, the media type of the media item is the audio, determining includes identifying one or more music characteristics from the audio, and mapping includes determining one or more colours from the one or more music characteristics based on a music-colour model and the at least one virtual keyboard feature is the one or more colours.

In yet another aspect, the present application describes a method of customizing a virtual keyboard on a computing device having a touchscreen. The method may include detecting a virtual keyboard customization trigger event; in response to detecting the virtual keyboard customization trigger event, identifying an image; determining two or more theme colours based on the image; applying each of the two or more theme colours to one or more respective keys of the virtual keyboard to generate a customized virtual keyboard; and rendering the customized virtual keyboard.

In some implementations, detecting the virtual keyboard customization trigger event includes detecting a change in position of the virtual keyboard on a display screen having a background wallpaper image, and identifying the image includes selecting a portion of the background wallpaper image over top of which the virtual keyboard is positioned as the image.

In some implementations, detecting the virtual keyboard customization trigger event includes detecting selection of a new background wallpaper image for display on a display screen on which the virtual keyboard is rendered and identifying an image includes selecting the new background wallpaper image as the image.

In some implementations, detecting the virtual keyboard customization trigger event includes detecting a change in active application from a first application to a second application, and identifying an image includes obtaining a screen shot image of the second application displayed on a display screen, and determining two or more theme colours based on the image includes determining two or more theme colours based on the image and at least one configuration parameter for the second application.

In some implementations, detecting the virtual keyboard customization trigger event includes detecting a game state change in a gaming application, and identifying an image includes obtaining a screen shot image of the gaming application displayed on a display screen.

In yet a further aspect, the present application describes a computing device having a touchscreen, one or more processors and memory. The memory may store executable instructions that, when executed, are to cause the one or more processors to carry out at least some of the operations of one or more of the methods described herein.

In an additional aspect, the present application describes a computer-readable medium that stored processor-executable instructions that, when executed by one or more processors, are to cause the one or more processors to carry out at least some of the operations of one or more of the methods described herein.

Other aspects and features of the present application will be understood by those of ordinary skill in the art from a review of the following description of examples in conjunction with the accompanying figures.

### BRIEF DESCRIPTION OF THE DRAWINGS

Reference will now be made, by way of example, to the accompanying drawings in which:

FIG. 1 shows an example of a virtual keyboard;

FIG. 2 shows, in flowchart form, one example method for customizing a virtual keyboard on a computing device;

FIG. 3 illustrates an example process of customizing a virtual keyboard;

FIG. 4 illustrates another example process of customizing a virtual keyboard;

FIG. 5 diagrammatically illustrates a further example process of customizing a virtual keyboard;

FIG. 6 shows a flowchart of an example process for customizing a keyboard based on multiple detected objects from an image;

FIG. 7 illustrates yet another example process of customizing a virtual keyboard;

FIG. 8 shows, in flowchart form, one example method for a state-change based customization of a virtual keyboard;

FIG. 9 shows, in flowchart form, a simplified method of cross-media type customizing a virtual keyboard;

FIG. 10 shows an example flowchart showing one simplified method of customizing colours of a virtual keyboard based upon text or speech input;

FIG. 11 shows an example flowchart showing one simplified method of customizing colours of a virtual keyboard based upon audio input;

FIG. 12 shows an example flowchart showing one simplified method of customizing a keypress sound effect of a virtual keyboard based upon text or image input;

FIG. 13 shows, in block diagram form, one simplified example of a computing device; and

FIG. 14 shows a simplified organization of software components stored in memory of the example computing device.

Like reference numerals are used in the drawings to denote like elements and features.

### DETAILED DESCRIPTION

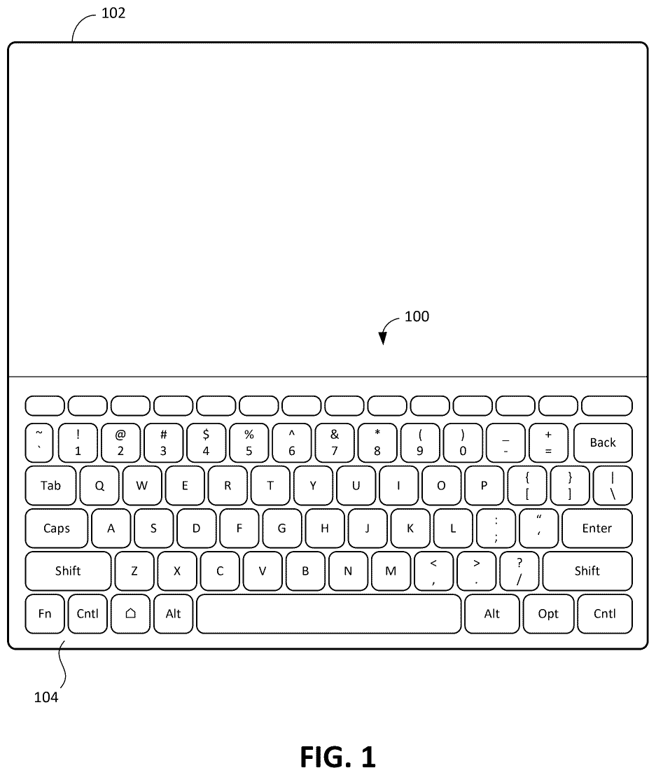

Reference will first be made to FIG. 1, which shows an example of a virtual keyboard 100. The virtual keyboard 100 is displayed or rendered on a display screen 102. The display screen 102 may be a touch screen and may be implemented within a computing device, such as a tablet, a laptop, a mobile device, or any other computing device that features a touch-sensitive display surface on which a keyboard may be displayed.

The virtual keyboard 100 includes a plurality of keys. In some cases, the virtual keyboard 100 may include a background field 104 and the keys may be rendered atop the background field 104 in a different colour than the background field 104 to make them visible. Each key, or most keys, may include a label indicating its associated function. The label may be a symbol and may be alphanumeric in some cases. Some of the keys may be “standard” keys and some may be “function” keys. In some cases, a subset of keys may be the alphanumeric keys, i.e. those keys to which a particular letter or number is assigned, and the remaining keys may be considered “function” keys. The function keys may include some typical function keys, like the space bar, enter key, shift key, etc., but some keyboards may include more unusual function keys.

Typing on a virtual keyboard can be difficult as compared to a conventional physical keyboard since there is no tactile feedback to the user from the feeling of the keys, their edges, and the feeling of a keypress. Conventional keyboards may be configured to have a mechanical feel to the keypress, such a click effect so that the user knows when the key has been depressed sufficiently to register an input and can be released.

Virtual keyboards lack the tactile feedback of a physical keyboard. Accordingly, they may sometimes feature an associated sound, i.e. an audio clip or file, that is played when a keystrike is detected. This may be a “click” or other such sound that is played through the speakers of the device with each keypress the device detects through the touch-sensitive display. In some cases, the virtual keyboard may display a visual or animated feedback from a keypress. For example, a detected keypress of a particular key may trigger the display of that key in enlarged form or in a different colour or with some other static or animated visual embellishment. In yet another example, the virtual keyboard may be configured to provide a vibratory feedback through use of a vibration device within the computing device that generates a short, sharp kinetic output with each detected keypress to signal to the user that the keypress was detected.

In addition to these types of parameters, virtual keyboards have the advantage of being highly customizable given than they are simply displayed on a screen. The colour of the keyboard may be changed by a user. In some cases, the user could specify a background image that serves as the backdrop image atop of which the keys are rendered.

Users often lack the capability to generate aesthetically pleasing graphical user interfaces. Those users that are capable will need to spend considerable time and effort setting custom parameters in order to realize a particular user interface. It may be advantageous to simplify and speed up the customization process associated with virtual keyboards so as to involve significantly fewer inputs and realize more visually distinctive results since the visual cues associated with certain customization may enable better typing outcomes than a uniform visual appearance. Because of the lack of tactile feedback, the user of a virtual keyboard relies on visual (and in some cases auditory) clues as feedback to ensure the user's fingers are positioned correctly and striking the intended ‘keys’. Those users that manually attempt to select custom colour parameters and features in order to customize a virtual keyboard may find that the result fails to realize visual cues sufficient to improve typing experience.

The customizable parameters or elements of the virtual keyboard 100 may, in various embodiments, include key colour and/or texture and/or the colour of any text or symbol on the key. Other example customizable parameters may include key colour when pressed (if configured to change when a keypress is detected), keyboard background colour, animations associated with a keypress, sound effect on keypress, vibration effect on keypress, or other such parameters.

In one aspect, the present application provides a method and computing device configured to customize a virtual keyboard based on an image that involves automatically determining a plurality of colours and applying them to respective keys of the virtual keyboard. In some examples, the plurality of colours is selected and applied in such a manner that the result is a gradient effect. The gradient effect may be in one direction or more than one direction. By introducing a visual gradient effect in the key colouring, a user is better able to visually determine the key locations and correctly position his or her fingertips for typing.

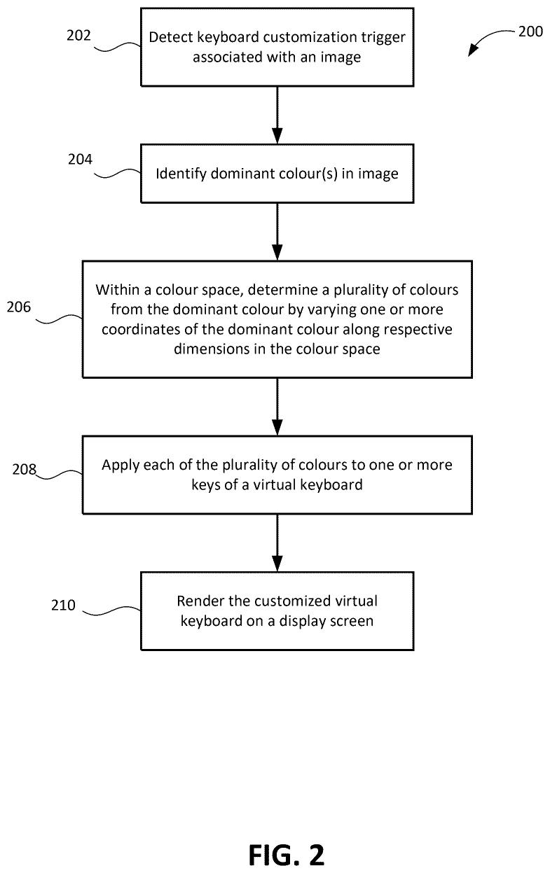

Reference will now be made to FIG. 2, which shows, in flowchart form, one example method 200 for customizing a virtual keyboard on a computing device. The method 200 may be implemented within software on the computing device, such as within the operating system software or within application software executing on the device.

In operation 202, the device detects a keyboard customization trigger associated with an image. In one example, as will be further shown below, the trigger may include user selection of an image and a drag-and-drop operation that moves the image on the touchscreen until it is at least partly overtop the virtual keyboard when it is released. That is the image is “dropped” onto the virtual keyboard. In some cases, at least a threshold portion of the image needs to be atop the keyboard to trigger keyboard customization. In some cases, the user may select an image and, through a menu item associated with image selection, instruct the device to carry out virtual keyboard customization based on the image. In some cases, the trigger may be selection of a keyboard customization menu item or icon, which prompts the user to select an image for the customization, and the subsequent receipt of a user selection of an image. The image may be stored locally on the computing device or may be downloaded to the computing device from a remote location over a network connection.

Other detected events may be keyboard customization triggers in some embodiments, some of which are described further below. For example, movement of the virtual keyboard to a different location of the touchscreen atop a background image may be detected as a virtual keyboard customization trigger, with the underlying portion of the background image serving as the associated image. In another example, a change in the background image, a change in the active application on the computing device, or a change in an application (e.g. game) state may be a trigger.

In operation 204, the computing device identifies a dominant colour in the image. Various image analysis algorithms may be used to identify a dominant colour in an image. In some cases, more than one dominant colour may be identified. In some cases, the various colours of an image may be clustered by an image analysis algorithm and a dominant colour may be identified as a colour associated with a cluster (e.g. midpoint) of colours that appear in greatest quantity in the image.

In operation 206, the computing device determines a plurality of colours within the colour space based on the dominant colour identified in operation 204. A colour space may be based on a colour model. For instance, a colour space may be based on the RGB colour model with each of the three colours assigned to an axis in a Cartesian colour space. A colour space may be based on an HSL or HSV (or HSB) colour model in some cases. The HSL and/or HSB model maps hue, saturation and lightness/brightness to dimensions of a space. Those dimensions may be mapped to a Cartesian space in some cases or, more commonly, to a cylindrical-coordinate space. In the latter space, the angle around the vertical axis maps to the hue parameter, the perpendicular distance from the axis maps to the saturation parameter, and the position along the axis maps to the lightness/brightness parameter. Other models and/or colour spaces may be used, including some with more than three dimensions in cases where more than three colour parameters are adjustable.

The dominant colour identified in operation 204 has a location or position, i.e. coordinates, in the colour space. In operation 206, the computing device varies at least one dimension of those coordinates to select a plurality of colours associated with (related to) the dominant colour. For example, the device may vary the hue by changing the angular coordinate, or may vary the brightness by varying the position along the axis. In some cases, the variation may be in both directions, such that the dominant colour is a midpoint of the plurality of colours. In some cases, the device may vary more than one colour parameter to produce the plurality of colours. For instance, it may vary both the hue and saturation, or may vary both the hue, saturation and brightness.

The variation may include shifting a colour parameter by a percentage along a dimension, e.g. a colour parameter may be varied by 5%, 10%, etc., where the percentage is based on the full range of that dimension in the colour space. The degree of variation may be user configurable in some cases. Larger variations will result in more noticeable colour differences in the plurality of colours, which may result is a more noticeable gradient effect on the virtual keyboard. If the device varies more than one dimension at a time, they may be varied by the same percentage or may be varied by different percentages.

In operation 208, the plurality of colours is applied to the keys of the virtual keyboard. In particular, each of the plurality of colours may be assigned to respective one or more of the keys. In one example the variation of colours is mapped to the vertical direction; that is, to respective rows of the keyboard. For example, the keys on the middle row of the virtual keyboard may be rendered using the dominant colour. The keys of the adjacent row of keys above the middle row may be rendered using a first variant within the plurality of colours, e.g. a colour shifted by 5% in one or more of the colour parameters. The keys of the row above the adjacent row are rendered using a second variant within the plurality of colours, e.g. a colour shifted by 10% relative to the dominant colour in one or more of the colour parameters. The keys of a row below the middle row may be rendered using a first negative variant within the plurality of colours, e.g. a colour shifted by −5% in one or more colour parameters, and so on.

In some cases, the variation may be mapped in the horizontal direction. That is the key colours may be assigned from the plurality of colours so as to shift key colours from left to right. In some cases, the plurality of colours may be mapped in two dimensions, e.g. both vertically and horizontally, thereby producing a two-dimensional gradient effect on the virtual keyboard.

Operation 210 indicates that the virtual keyboard customized by the plurality of colours is displayed on the display screen of the computing device.

In some embodiments, more than one dominant colour may be identified in operation 204. For example, a first most dominant and a second most dominant colour may be identified from the image. One of the dominant colours may be used to colour a subset of keys and the other of the dominant colours may be used to colour the remaining keys. For instance, a most dominant colour may be used to colour the ‘standard’ or alphanumeric keys, and the second dominant colour may be used to colour the ‘function’ keys. The selection of a plurality of colours based on a dominant colour and the mapping of those plurality of colours to respective keys of the keyboard may be carried out for one or both of the standard keys and function keys. A plurality of colours may be determined for the first dominant colour and a different plurality of colours may be determined for the second dominant colour.

In some cases, when applying a colour to a key in operation 208 the device may select a contrasting colour for rendering the symbol or alphanumeric character on the key. The contrasting colour may be selected based on a colour theory or algorithm mapping contrasting colours, such that the colour applied to the key deterministically identifies the contrasting colour used for rendering the symbol or character.

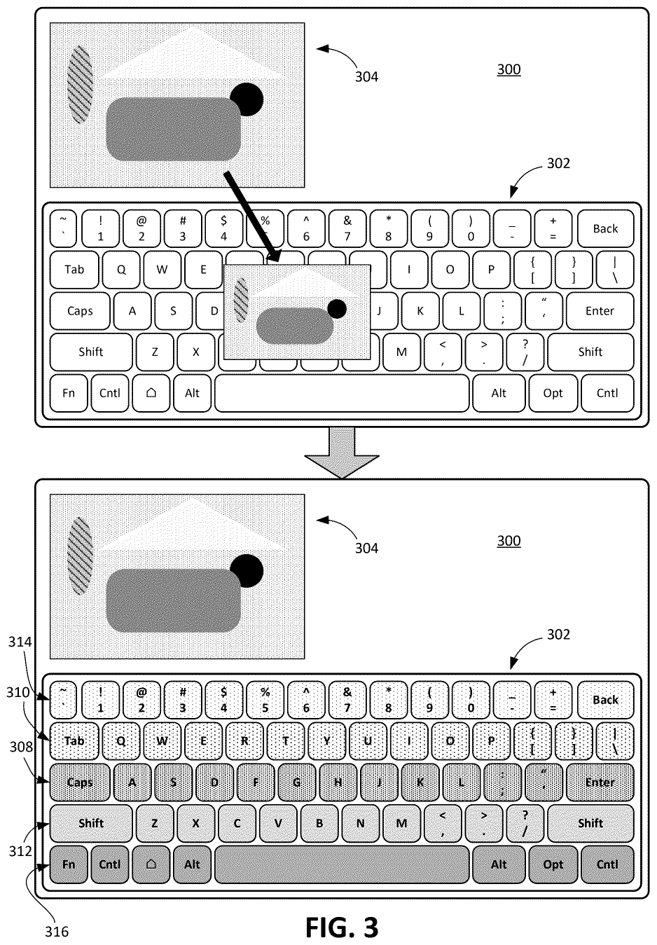

FIG. 3 diagrammatically illustrates an example process of customizing a keyboard in accordance with the method 200 of FIG. 2. A touch sensitive display screen 300 displays a virtual keyboard 302. The virtual keyboard 302 may be rendered on the display screen 300 in a default set of colours that may be determining in accordance with a selected theme for the interface. The theme may be set by an application or by the operating system and may be user-selectable in some instances.

A portion of the display screen 300 not covered by the virtual keyboard 302 may display, for example, background wallpaper, or more applications, icons, menus, or other graphical user interface items. In some cases, the portion may show an image or a thumbnail of an image, such as image 304. In accordance with normal operation of the operating system and the touch sensitive display screen 300, the image 304 may be selectable and may be capable of being ‘moved’ on the display screen 300 in a typical drag-and-drop operation. In this example, a touch event initiated by a user selects the image 304 and, as indicated by arrow 306, the image 304, or a thumbnail of the image 304, is moved over top of virtual keyboard 302, i.e. ‘dragged’, whereupon it is released, i.e. ‘dropped’. By dragging-and-dropping the image 304 onto the virtual keyboard 302, the user signals to the device that the image 304 is to be used in customizing the virtual keyboard 304. In other words, the drag and drop operation involving an image is a virtual keyboard customization trigger event.

The trigger event causes the operating system and/or a keyboard customization module or application to carry out operations such as those described above in relation to FIG. 2. That is, the image is analyzed to identify one or more dominant colours. In a first example, a single dominant colour is identified and the location (e.g. position or coordinates) of that dominant colour within a colour space is determined. A plurality of colours within the colour space are then determined based on the dominant colour by adjusting the position or coordinates in a least one direction within the colour space. This may result in a selection of colours of different hues, or intensities, or saturation, or a combination of two or all three of those colour parameters. The plurality of colours may be determined by varying at least one dimension of the coordinates in colour space by a fixed percentage or value in one direction or the other. In some cases, the dominant colour is set to be at one end of the range of the plurality of colours in that the other colours in the plurality of colours all vary in one direction (positive or negative) along a coordinate axis from the position of the dominant colour. In some cases, the dominant colour is set to be in the center of the range of the plurality of colours in that the other colours in the plurality have positions that range along a coordinate axis on either side of the position of the dominant colour. In some cases, the positions of the other colours vary along more than one coordinate axis from the position of the dominant colour, i.e. in two or more dimensions within the colour space.

Having determined a set of colours within the colours space based on the dominant colour, those colours are then mapped to one or more respective keys of the virtual keyboard. In this example, the dominant color may be applied to the “home” row 308 within the middle of the five rows of the keyboard. A ‘next’ colour in the plurality of colours that varies in at least one respect within the colour space, for example constituting a 5% shift in hue towards a lighter blue shade, is applied to an upper adjacent row 310 above the home row 308. Similarly, a colour that varies in at least one respect in an opposite direction within the colour space, for example a −5% shift in hue towards a darker blue shade, is applied to a lower adjacent row 312 immediately below the home row 308. A top row 314 may be coloured using a colour shifted by slightly more than the upper adjacent row 310, such as a 10% shift in hue vis-á-vis the hue of the dominant colour. A bottom row 316 may be coloured using a colour shifted the opposition direction and more than the lower adjacent row 312, such as −10% shift in hue. In this manner, the dominant colour identified within the image 302 serves as the basis for identifying a set of colours within colour space that may then be applied to select portions of the virtual keyboard 302 to result a gradient-effect.

In this example, the plurality of colours are applied such that each of the five colours is applied to a respective row. In some cases, the application may be different. For instance, the colours may be applied in columns of keys or other groupings of keys. In some cases, the alphanumeric keys may be coloured using one colour and the ‘functional’ keys may be coloured using a different colour. In some cases, the mapping of colours to keys may vary in two dimensions, such that slightly different colours are applied to every key, resulting in a colour parameter shift in two dimensions across the keyboard. For example, the hue may vary from a darkest hue at the bottom right to a lightest hue in the top left. In another example, the brightness and saturation may shift from bottom left to top right. Other mappings may be used in other implementations. In some implementations, the shift or gradient in colours applied in one or two dimensions across the keys of the keyboard may be based on varying of two or more colour parameters.

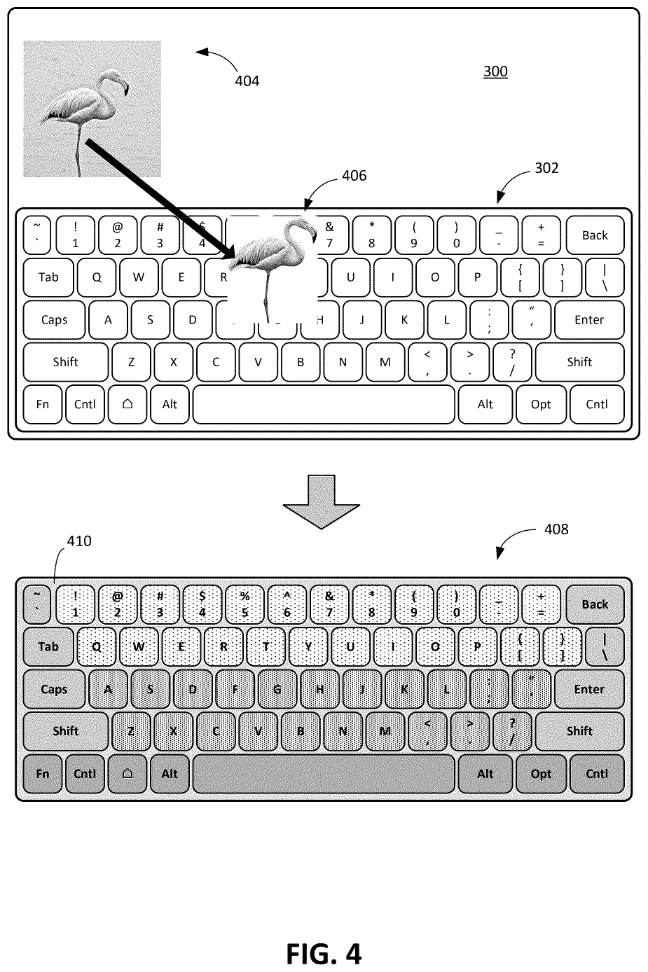

FIG. 4 diagrammatically illustrates another example process of customizing a keyboard. In this example, a touch-sensitive display screen 400 shows a virtual keyboard 402 on one portion of the display screen 400 and an image 404 on another portion of the display screen 400. The virtual keyboard 402 may be coloured in accordance with a default theme or colour palette or may have been previously customized based on some earlier input.

The image 404 contains an object 406. In this example, the object 406 may be selected by an object segmentation or object detection operation. In some cases, this operation is initiated through user input, such as user selection of the object using a touch event or a menu command. The user input may instruct the system to conduct an image analysis, perhaps based on one or more selected points within the image, in order to identify the boundaries of a detected object within the image. The system may apply a mask or other image modification operation to generate a copy of the object selected from the image in some cases. A touch-and-drag operation may be carried out by the user to ‘move’ the selected object on the display screen 400. The object 406 may be a primary or dominant object within the image in some cases or may not be the primary or dominant object, particularly if user input is utilized in identifying and selecting the object 406.

In this example, the object 406 is selected and ‘dragged’ on top of the virtual keyboard 402. A release of the drag operation, e.g. ‘dropping’, the object 406 atop the virtual keyboard 402 is a trigger event to initiate keyboard customization based on the image 404 and, in particular, the object 406. The keyboard customization operation may be substantially similar to the process described above in connection with FIG. 2, but may use the object 406 alone in determining the one or more dominant colours. That is, the dominant colour analysis may be carried out using the object 406 selected from the image 404. In some cases, this may result in a different set of dominant colours than if carried out on the image 404 as a whole. The one or more dominant colours from the object 406 may then be used to find a set of colours in a colour space based on the position of the dominant colour(s) and through variation of one or more colour parameters within the colour spaces. That set of colours may then be applied to the keys, as described above, to result in a customized virtual keyboard 408. The

In some cases, the remainder of the image 404 may be used to identify one or more background colours, e.g. “not-object” colours. In some cases, the object identification operation may identify more than one object and all the identified objects may be excluded from the image 404 when conducting the analysis of the image 404 to find one or more dominant background colours. The identified one or more background colours may be applied to colour a background portion 410 of the customized virtual keyboard 408. The background portion 410 is that portion of the customized virtual keyboard 408 surrounding the keys.

In some cases, having identified a dominant colour of the object 406 and a dominant colour of the background, the system may carry out a pairwise analysis to verify that the two colours are sufficiently distinct. If too close together in colours space, e.g. not more than a minimum distance in certain dimensions, then the colours may be too similar and a different background colour may be identified, in some cases based on selecting a second most dominant colour from the background, etc.

Text colour for labelling of keys may be selected based on ensuring a contrast between the key colours applied to each key and the text colour. In some cases, the key colours are black or white and are selected based on a brightness level of the applied colour on the key. In some cases, a colour mapping may be used to select a high contract text colour based on the key colour.

In some implementations, the dominant colour analysis of the object 406 is used to identify at least a first dominant colour and a second dominant colour within the object 406. In these implementations, a set of colours is not necessarily determined within a colour space based on the dominant colour analysis. Instead, the identified first dominant colour and second dominant colour are directly used to colour respective ones of the keys. For example, the first dominant colour may be used to colour the alphanumeric keys and the second dominant colour may be used to colour the remaining keys. Additional dominant colours may be used to colour other subsets of the keys. The resulting effect is not necessarily a gradient effect, but instead is a customized colouring of the keycaps based on dominant colours within an object detected within an image.

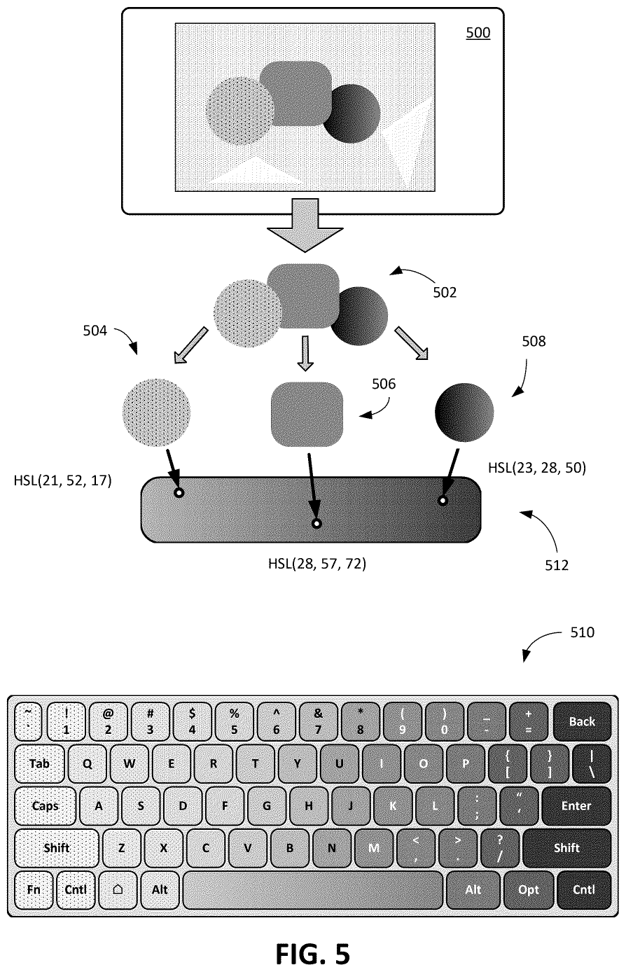

Reference is now also made to FIG. 5, which diagrammatically illustrates a further example of customizing a virtual keyboard. As with FIG. 4, in this example, an image 500 is used to determine colours for the virtual keyboard; however, in this example, the image 500 contains multiple detected objects 502. The objects may be selected by a user and/or identified using an object detection and segmentation algorithm. In some cases, the objects are detected, identified and selected on the basis that they are related in nature, e.g. all of the same class or category. That is, the algorithm may be configured to co-selected two or more objects detected within an image if the objects are related in class; for example, vehicles, people, animals, etc.

As above, the keyboard customization operation may be triggered or initiated in part through a drag-and-drop operation with regard to the virtual keyboard. For example, the user may drag-and-drop the image onto the virtual keyboard, which may trigger the image analysis and object identification. The user may select the image or a point in the image, which may initiate the object identification and segmentations, and the one-or-more detected objects may then be drag-and-dropped from the image onto the virtual keyboard. The group of objects may be selected and dragged together, or may be individually selected and drag-and-dropped serially onto the keyboard.

A dominant colour analysis may be carried out with regard to each of the identified and selected objects. That is, each identified object may be analysed to find the dominant colour(s) in that object. The location of each of the dominant colours in colour space may then be determined.

Once the dominant colour or colours of each object have been determined, the system may then determine a set of colours based on those dominant colours. For example, the set of colours may include the dominant colours and a number of colours “between” those dominant colours. For example, the dominant colours have corresponding coordinates 512 within the colour space. The ‘distance’ between those dominant colours may be partitioned based on the number of colours desired and points along the trajectory within colour space between the dominant colours may then be identified as the additional colours with the colour set.

In some cases, the position of the objects within the image may determine which trajectories between dominant colours within the colours space are used to determine the additional colours within the colour set. For example, the multiple detected objects 502 may include a leftmost object 504, a rightmost object 508 and a middle object 506, generally positioned horizontally across the image 500. Based on this configuration of objects, the set of colours may be based on finding a first subset of colours within the colours space along the multi-dimensional trajectory from the coordinates of the leftmost object 504 to the middle object 506 and finding a second subset of colours within the colours space along the multi-dimensional trajectory from the coordinates of the middle object 506 to the rightmost object 508.

The set of colours determined in colours space based on the dominant colours of the multiple detected objects 502 may then be applied to the virtual keyboard to generate a customized virtual keyboard 510. As described earlier, each colour in the set of colours may be applied to one or more of the keys. This may be carried out to realize a gradient effect on the customized virtual keyboard 510 that is generally based on the dominant colours of the multiple detected objects 502 from the image 500. As above, a background dominant colour of the image 500 may be used to color the background portion of the customized virtual keyboard 510 in some cases.

In some embodiments, the mapping of the colours to the keys may be at least partly based on the relative positioning of the multiple detected objects 502 within the image 500. In the example shown in FIG. 5, the objects are positioned generally horizontally relative to each other within the image 500. Accordingly, the variation in the set of colours may be mapped so as to be applied horizontally across the virtual keyboard. In another example, two or more objects may be positioned vertically relative to each other in the image, in which case the system may map the set of colours so as to vary the colours vertically up and down the virtual keyboard. In a further example, the two or more objects may be relatively offset from each other in two dimensions and that relative shift in position may be used to map the colours of the set of colours to the customized virtual keyboard such that they vary in a similar two-dimensional direction.

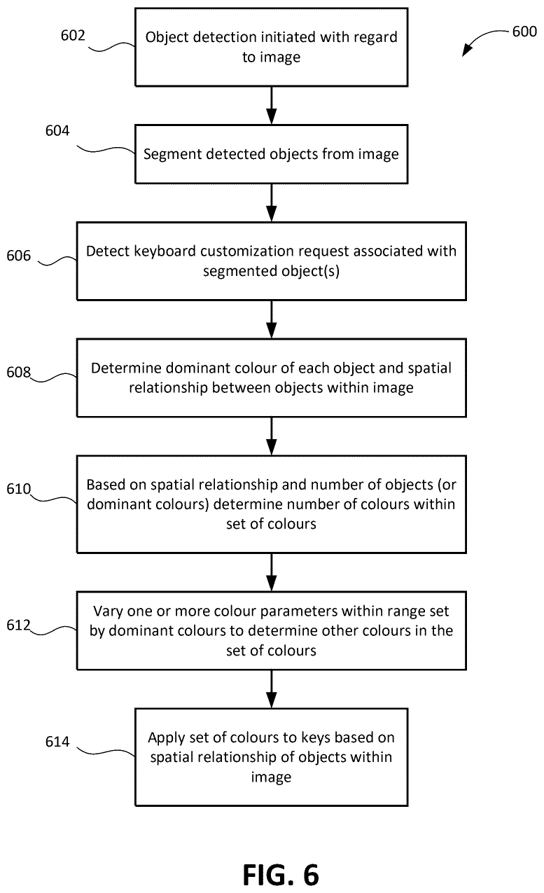

FIG. 6 shows a simplified flowchart of an example process 600 for customizing a keyboard based on multiple detected objects from an image.

In operation 602, an object detection operation is initiated with regard to an image. This may be carried out in response to selection of a menu option within a user interface. It may be carried out in response to detection of a long-hold touch selection of the image. The point(s) selected within the image may be a seed point in the object detection operation in some cases. In operation 604, the object detection operation results in segmentation of detection objects from the image. That is, the boundaries of the detected objects within the image may be determined and a masking operation may be applied to select the portion of the image containing the detected objects. In the example case of a “touch-and-hold” operations on the touchscreen with regard to the image, the segmentation may result in rendering the segmented objects atop the image and permitting a drag operation with regard to the segmented objects, enabling the movement of the selected objects to other areas of the touchscreen.

In operation 606 a keyboard customization request is detected. In some cases, this may be detected through detecting a ‘drop’ operation with regard to the selected objects when they are dragged over top the virtual keyboard. That is, the selected objects may be dropped onto the virtual keyboard. In some cases, at least a minimum portion of the selected object is determined to be positioned over the keyboard before the keyboard customization operation is detected.

When the keyboard customization request is detected in association with multiple selected objects from an image, then in operation 608 the system determines at least one dominant colour for each of the detected objects. In some cases, this may include further segmenting the selected multiple objects to partition it into individual objects, if not already segmented. Each object may be analyzed to determine a dominant colour of that object. Clustering may be used in the image analysis to find a dominant colour. The spatial relationship of the objects within the image may also be determined. The spatial relationship may indicate whether the objects are arranged horizontally or vertically. The spatial relationship may indicate relative spacing between three or more objects. The spatial relationship may indicate a two-dimensional relationship between each pair of the three or more objects.

In operation 610, the system may determine the number of colours within a set of colours. The number of colours may be partly based on the spatial relationship. For example, if the relationship is vertical, such that the system requires five colours to colour five rows or keys, then the number of colours may be determined to be five. If the relationship is horizontal, then the system may determine that there are 8-12 different columns of keys to be coloured and may determine that there are to be 8-12 colours in the set of colours. In some cases, the system sets the number of colours to be the number of keys on the virtual keyboard.

In operation 612, the system determines the colours in the set of colours through varying one or more colour parameters of the dominant colours of the objects. In some cases, the variation is along a trajectory in colour space between a pair of the dominant colours. In some cases, the coordinates of the dominant colours set the range and the variation is selected from within the range. The number of variations of the parameters may be determined based on the number of colours required to build the set of colours. In some cases, a shorter hue interpolation method may be used in generating the colours.

Once the set of colours has been determined from the dominant colours in the objects detected, then in operation 614 the colours of the set of colours are used to colour the keys of the virtual keyboard. That is, each key may be assigned one of the colours from the set of colours. The mapping of colours to keys may be based, in part, upon the relative location of the objects within the image. That is the spatial relationship between the objects in the image may be replicated in mapping the set of colours to the virtual keyboard, thereby creating a gradient effect on the keyboard that mirrors the physical spatial relationship of the objects in the image.

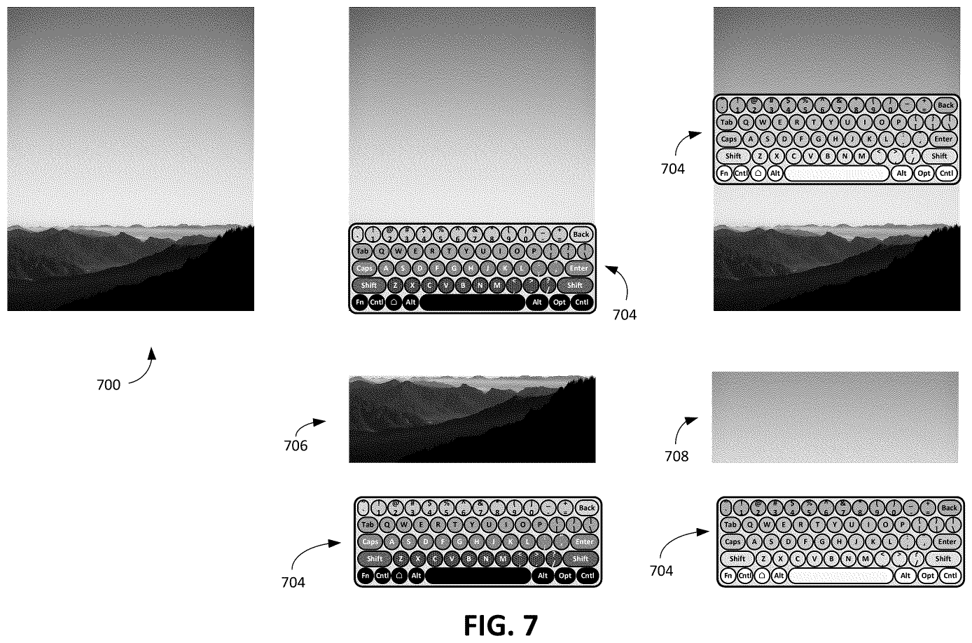

Reference is now made to FIG. 7, which shows another example process of customizing a virtual keyboard.

In this example, a touchscreen display 700 has a background wallpaper image. The background wallpaper image may have a number of colours having different colour parameters in different regions. This may particularly be the case where the background wallpaper image is a photograph.

A virtual keyboard 704 may be positioned over a first portion of the image when in a default location on the touchscreen 700. The default location may a position adjacent a bottom edge of the touchscreen 700 when in its current orientation. The system may be configured to select or segment from the wallpaper image that first portion of the image over which the virtual keyboard 704 is positioned. That first portion of the image segmented from the image is indicated by reference numeral 706.

The system may be configured to colour the virtual keyboard based upon the first portion 706 of the image. That is, the first portion 706 of the image may be used as the input to a keyboard customization process, such as that described above in connection with FIG. 2 for example. In other words, one or more dominant colours of the first portion 706 of the image may serve as the colours for colouring the virtual keyboard 704 and/or may serve as the basis for selecting colours within a colour space to build a set of colours that are then used to colour the keys of the virtual keyboard 704, such as using one or more of the techniques described above.

In some cases, the virtual keyboard 704 may be moveable on the touchscreen 700. For example, in some cases, the virtual keyboard 704 may repositioned based on a detected user input shifting the location of the virtual keyboard 704. As an example, the system may detect a long-hold touch event on a portion of the virtual keyboard as a “selection” operation that result in enabling a drag operation through the touchscreen 700 and through which the user may move the virtual keyboard 704 to a new location on the touchscreen 700. In another example, the position of the virtual keyboard 704 may change as a result of rotation of the touchscreen 700 to a new orientation.

The repositioning of the virtual keyboard 704 to a new location in which it sits atop a different portion of the background wallpaper image may be detected as a trigger to initiate a virtual keyboard customization operation. That is, the positioning of the keyboard in a new location may trigger the system to identify and segment the new portion of the background wallpaper image covered by the keyboard and to then use that new portion in a virtual keyboard customization process, such as one of those described above. The new portion of the image segmented from the image is indicated by reference numeral 708. That new portion 708 may feature different colours having different colour parameters than the first portion 706. The dominant colour analysis may result in selection of one or more different new dominant colours and, as a result, a different set of colours applied to the virtual keyboard 704.

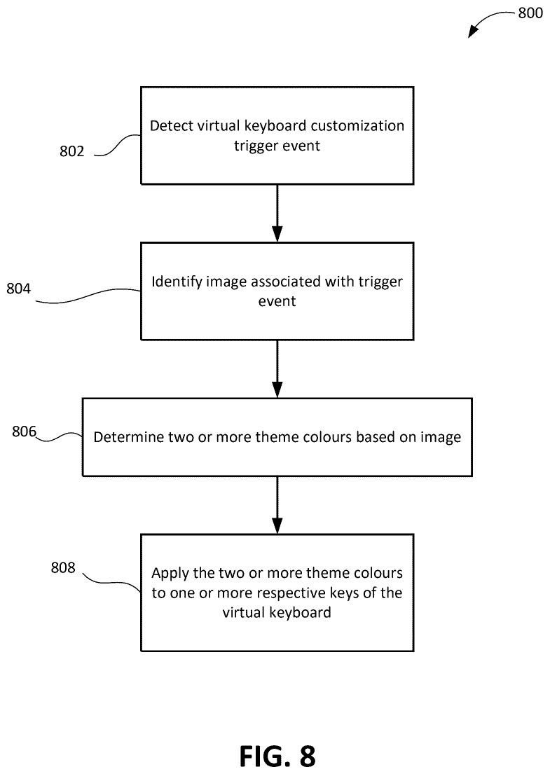

FIG. 8 shows, in flowchart form, one example method 800 for customizing a virtual keyboard. The method 800 may be implemented by a computing device having a touchscreen display. The method 800 may be implemented by way of software instructions stored in memory in the computing device and that, when executed by one or more processors of the computing device, cause the one or more processors to carry out the described functions. The software instructions may be implemented within operating system software in some cases. Th software instructions may be implemented within application software in some cases.

In operation 802, the computing device detects a virtual keyboard customization trigger associated with input media. The input media in this case is an image. In operation 804, the computing device identifies the image associated with the trigger. In operation 806, the computing device determines two or more theme colours based upon the image. For example, the image may be analyzed to determine two or more dominant colours. Colours within the image may be clustered and from the clustering the device may identify the two or more dominant colours. In some instances, the gradient-effect process and/or object segmentation processes described above may be applied in determining the two or more theme colours. In operation 808, the two or more theme colours are applied in rendering the virtual keyboard on the touchscreen of the computing device.

The trigger in operation 802 may be a system level change in some cases. In one example, the trigger in operation 802 is detection of a change in the virtual keyboard position atop a background wallpaper image, as described above in connection with FIG. 7.

In another example, the trigger may be selection of a new wallpaper image. That is, when the user changes the wallpaper image on the computing device, then the device may determine a new keyboard colour theme based upon the new wallpaper image for the touchscreen. In one example, the identification of the image in operation 804 is identification of the new wallpaper image; that is, the whole image is used in determining the new keyboard theme. In another example, the identification of the image includes identifying the portion of the new wallpaper image covered by the virtual keyboard. In yet another example, the identification of the image includes identifying the portion of the wallpaper image not covered by the virtual keyboard.

Another example trigger event may be determination that the active application executing on the computing device changes. That is, focus may change from one active application to another active application, or a new active application may be launched through selection of its icon for example. The change in active application may include change of the active window. In some cases, the active window occupies the touchscreen or at least the portion of the touchscreen not occupied by display of the virtual keyboard, if any is visible. When the active application changes, the computing device may be configured to obtain an image of the active application. For example, the device may obtain a screen shot image of the active application displayed on the touchscreen. That is, identifying the image associated with the trigger in operation 804 may include obtaining a screen shot of the active application displayed on the touchscreen. In some implementations, the device may further obtain theme parameters from the active application. In other words, the active application may specify certain theme parameters, such as one or more colours, one or more images, etc. in a config file or other data file. The screen shot image and/or active application theme parameters may be used as the basis for determining a set of colours for customization of a virtual keyboard while the active application is active. In some cases, the virtual keyboard is only displayed if the active application enters a user input mode, i.e. soliciting user keyboard input, in which case the virtual keyboard is then rendered using the colour scheme set by the two or more theme colours.

In yet another example, the trigger event may be a state change at the application level. For example, the trigger may include detecting a state change within a gaming application using an API associated with the gaming application. It may include detecting a greater-than-threshold change in the game scene display, such as a greater-than-threshold in colour distribution. In such a case, a screenshot of the current game display may be obtained and analyzed to identify the two or more theme colours.

In any of the above example, contextual system level or application level changes are detected and an associated image is identified and then used as the basis for determining two or more theme colours. Those colours are then used in customizing the virtual keyboard rendered on screen.

In another aspect, the present application describes virtual keyboard customization processes in which a customization request is associated with a media item in one format and the keyboard feature customized based on the media item is a feature in a different media format. In some cases, this includes determining a mapping of a characteristic of the media item to one or more parameters or characteristics in the different media format.

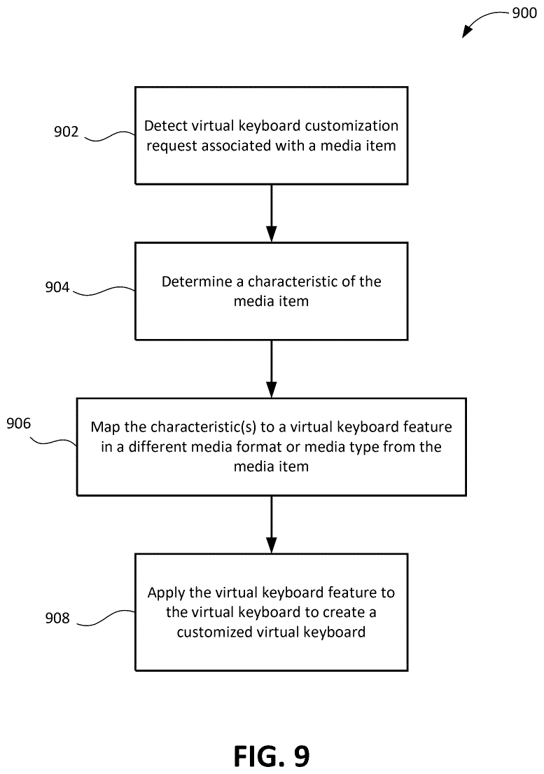

FIG. 9 shows, in flowchart form, a simplified general method 900 of customizing a virtual keyboard. The method 900 may be implemented by a computing device having a touchscreen display. The method 900 may be implemented by way of software instructions stored in memory in the computing device and that, when executed by one or more processors of the computing device, cause the one or more processors to carry out the described functions. The software instructions may be implemented within operating system software in some cases. The software instructions may be implemented within application software in some cases.

In operation 902, the device detects a virtual keyboard customization request. As described above, this request may be initiated through selection of a menu item or setting, through drag-and-drop of a media item onto the virtual keyboard on a touchscreen display, or through other triggering events. The media item associated with the triggering event is of a particular media format, such as an image, text, audio (e.g. speech, music, or sound effects), or other such categories of media.

In operation 904, the device determines at least one characteristics of the media item. For example, it may determine, using object recognition, an object in an image, such as an animal. In the case of text input, the device may determine one or more characteristic words based on the text input. It may filter the text to obtain one or more characteristic words in some cases, or to remove extraneous words. In the case of audio, it may determine whether the audio is speech audio or sound/music audio. If speech is detected, then the device may convert the speech to text in some cases. A speech-to-text converter may be employed to obtain text from the input speech audio. In the case of music, the device may detect a music type or genre or artist, or it may determine the song or album title, or other such characteristics.

In operation 906, the media item and/or its one or more characteristics may be used to determine at least one virtual keyboard feature. The virtual keyboard feature is of a media type different from the media time of the media item associated with the trigger event. That is, if the media item is an image or a portion of an image, then the virtual keyboard feature may be a sound or animation effect, for instance. If the media item is, for example, text and/or speech, then the virtual keyboard feature may be a keypress sound effect and/or a keyboard colour theme. If the media item is music, then the virtual keyboard feature may be a keyboard colour scheme, etc. The particular virtual keyboard feature(s) selected are based on the media item and/or its one or more characteristics. Illustrative examples are provided below.

In operation 908, the virtual keyboard feature(s) is applied to the virtual keyboard on the computing device, thereby providing a customized virtual keyboard. This may include rendering the keyboard in accordance with a custom determined keyboard colouring scheme in some cases. It may include equipping the keyboard with a custom selected keypress sound. It may include providing the keyboard with a custom determined animation effect during keypress of one or more of the keys. Other such thematic media customizations may be determined and included in some cases.

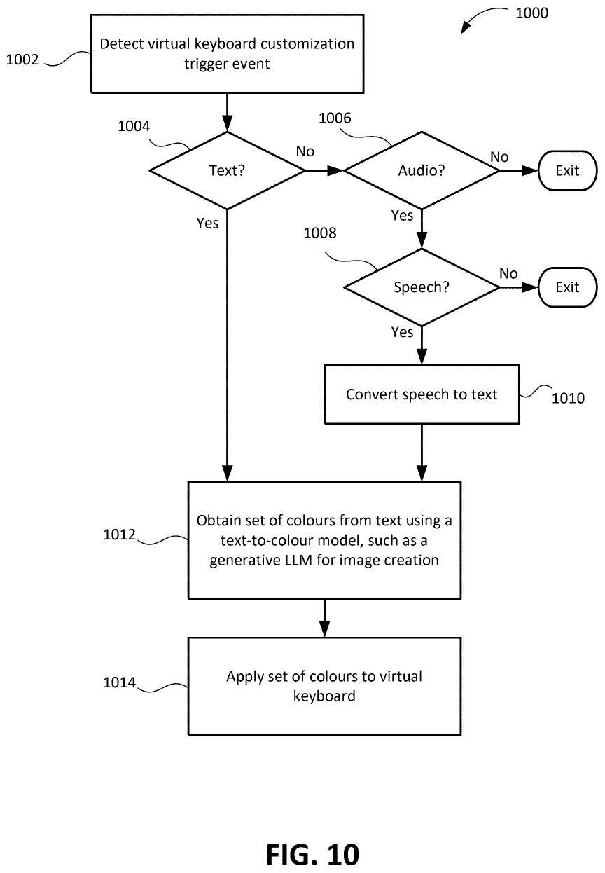

In one example, the computing device determines a virtual keyboard colour scheme based upon a text or speech input. FIG. 10 shows an example flowchart showing one simplified method 1000 of customizing colours of a virtual keyboard based upon text or speech input.

In operation 1002, the computing device detects a virtual keyboard customization request or trigger event. Example trigger events may include user selection of a virtual keyboard customization menu item or application or configuration setting. In some cases, displayed text or an input audio file may be drag-and-dropped onto the virtual keyboard as a trigger event. In some implementations, other mechanisms may be used to cause the device to detect a request to customize the virtual keyboard in association with a text or audio input.

In operation 1004, the device determines whether the input is text. In some cases, there may be a maximum quantity of text set to limit the size of the input text, e.g. 500 or 1000 characters. If it is not text, then the device determines whether the associated input or file is in an audio format in operation 1006. If not, the associated input or file is not audio or text, then the method 1000 exits. In some cases, the device may be configured to handle other media formats or types, as described in other examples herein; however, this simplified example is limited to text and speech handling.

If the associated input or file is audio, then in operation 1008 the device engages in speech detection to determine whether the audio input or audio file is human speech or other audio (e.g. music, ambient sounds, sound effects, etc.). If speech is not detected, then the method 1000 exits. As noted above, the device may be configured to handle other audio types, as described in other examples; however, this simplified example is limited to text and speech handling. In operation 1010, having determined that the associated input audio or audio file is human speech, the device converts the speech to text. Any suitable speech-to-text converter may be employed.

In operation 1012, the associated text or the text obtained from speech are then used to determine one or more colours for the virtual keyboard. In a first example, the text is processed and analysed using natural language processing (NLP) techniques. The NLP operations may include text cleaning and entity recognition. Entity recognition may involve labelling text input, mainly categorizing the text into subject categories and identifying background keywords related to the subject. Once the text is labelled, a text-to-colour model may be used to map the labelled text to one or more colour codes. In some cases, the text-to-colour model may include a neural network training to map subjects and/or keywords to colour codes. In one example, a large language model trained on subject, background, keyboard color code dataset is used for generating color codes.

In a second example, the device run a generative text-to-image model to generate an image from the text input. That is, the input text is effectively used as a prompt to a generative LLM trained to output images based on text prompts. Once an image is generated from the text input, the device determines the one or more colours from the image. Techniques like those described above, involving identification of one or more dominant colours, object recognition, and the like, may be employed to determine the set of one or more colours from the generated image.

In operation 1014, the set of colours determined in operation 1012 is then used to render the customized virtual keyboard on the display screen.

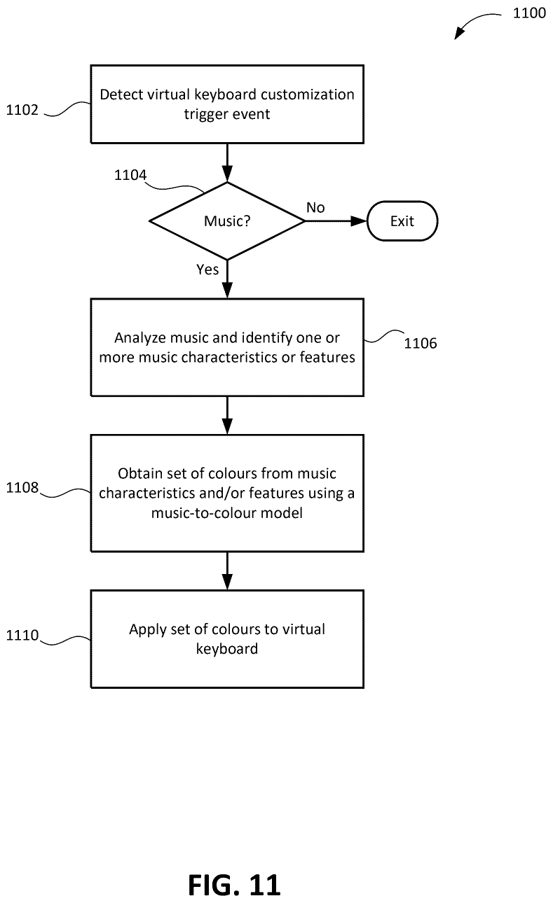

In another example, the computing device determines a virtual keyboard colour scheme based upon a non-speech audio input. In other words, the audio input is used to determine a keyboard colour scheme without converting the audio to text. FIG. 11 shows an example flowchart showing one simplified method 1100 of customizing colours of a virtual keyboard based upon audio input.

In operation 1102, the computing device detects a virtual keyboard customization request or trigger event associated with an audio input. Example trigger events may include user selection of a virtual keyboard customization menu item or application or configuration setting. In some cases, an audio file may be drag-and-dropped onto the virtual keyboard as a trigger event. In some implementations, other mechanisms may be used to cause the device to detect a request to customize the virtual keyboard in association with an audio file or audio input. In some cases, the trigger is initiated and the microphone(s) on the computing device is enabled to receive audio input. Input via the microphone may be processed in real time or may be recorded and processed as a stored audio file.

In operation 1104, the computing device determines whether the audio is music. In some cases, operation 1104 may include determining whether the audio is speech input and, if speech is detected, the method 1100 exits. As noted above, speech may be handled in another manner or using another process. If the audio is music (or at least not-speech), then in operation 1106 the computing device may analyze the music to identify one or more features of the music (or other audio type). Example features may include the music genre, tempo, rhythm, pitch, key, dynamics, chords, instrument, etc. In some cases, the features may include the song title, artist, album title, etc. Some of the features may be determined using open-source libraries in some implementations.

After one or more of the features are detected, in operation 1108 the device then determines a set of two or more colours based upon the one or more features of the music. A mapping of features to colours may be used in some cases. Music-colour theory, e.g. chromesthesia, may be used in implementing a music-to-colour mapping. In some cases, a machine-learning model may be employed that has been trained to take music feature inputs and map them to one or more colours. A model may map certain sound features to certain colour parameters. For example, louder, deeper base tones and ‘heavier’ sounds may be mapped to darker more saturated colours, whereas lighter, higher pitched, softer tones may be mapped to lighter colours. The set of colours determined based on the music is then applied to the virtual keyboard in operation 1110.

In one variation, the audio input may be a continuous input that the computing device analyzes in real time to determine whether there is a threshold level of change in one or more of the music features. A greater-than-threshold change in the music features may prompt the device to re-determine the set of colours and to re-customize the virtual keyboard with a new set of colours that correspond to the current music. In other words, the virtual keyboard may adapt its colour scheme contextually based on changes in the ambient music. The music may be input to the device via a microphone from an external source in some cases. In some cases, the music is being played by the computing device and output through one or more speakers and/or headphones associated with the computing device, and may be routed directly to the keyboard customization process without routing through speakers/microphones. The music may be associated with a multimedia video (e.g. movie), a gaming application, a streaming service, or any other such source.

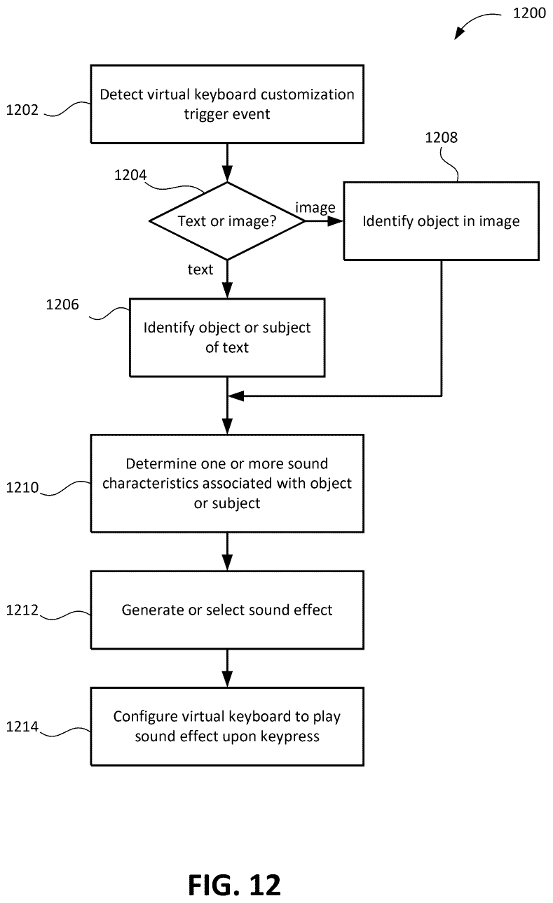

In a third example of cross-media-type customization, the computing device may determine a virtual keyboard keypress sound based upon a text or image input. In other words, the text or image input is used to determine a sound effect. FIG. 12 shows an example flowchart showing one simplified method 1200 of customizing a keypress sound effect of a virtual keyboard based upon text or image input.

In operation 1202, the computing device detects a sound effect customization request or trigger event associated with a text or image input. Example trigger events may include user selection of a customization menu item or application or configuration setting. In some cases, an image or selection of text may be drag-and-dropped onto the virtual keyboard as a trigger event. In some implementations, a portion of an image, segmented by an object recognition algorithm, may be selected from an image and drag-and-dropped onto the virtual keyboard. Other mechanisms may be used to cause the device to detect a request to customize the keypress sound effect in association with a text input or an image.

In operation 1204, the computing device may distinguish whether the request is associated with input text or with an image. If text, then in operation 1206 the device may analyze the text to identify a primary object, e.g. subject of the text. This may include determining whether the text relates to an identifiable object or not. If the input associated with the request is an image or a selected portion of an image then in operation 108 the device may identify an object in the image. An object recognition algorithm may be used to identify and classify an object in an image.

Optionally, once an object or subject of the image/text has been identified, then in operation 1210, the computing device may determine one or more sound characteristics associated with the object or subject. For example, the object may be determined to fall within a category or class, such as animals, weather, vehicles, etc. Those classes or categories may have dedicated sound libraries or models associated with them. In some cases, operation 1210 may include determining whether the identified object can be associated with a sound characteristic. Certain objects, such as animals, vehicles, etc., may have directly associated sounds. For instance, an image of a bird or of a particular, bird, like a hawk or raven, may have a somewhat specific sound characteristic with which it is associated. Other objects or subjects may be less directly connected to a particular sound characteristic. For example, if the object is something like a flower or a mountain or a fruit, it may not have a characteristic sound; however, it may be possible to determined associated sound-like terms for the object. An object like mountain might be associated sound-like terms such as storm, avalanche, etc. Accordingly, operation 1210 may, in some implementations, carry out word association to map an object to terms that are sound-like or sound characteristics.

In operation 1212, a sound effect is selected or generated based on the object/subject and/or the sound characteristic(s) determined in operation 1210. In some cases, the sound effect may be selected from a library of sound effects based on a keyword matching or based on best-match between sound characteristic(s) and tags within the library. In another example, a sound effect may be generated based on the object/subject and/or the sound characteristic(s). For example, the device may employ a text-to-sound model, possibly implemented using a pre-trained LLM, to generate a sound effect associated with the object/subject. In some cases, the object or subject and/or the sound characteristics may be used as a text prompt input to the LLM to obtain a sound effect. The sound effect selected or generated is stored on the device as an audio file. In operation 1214, the device is configured to use the sound effect for one or more detected keypresses of the virtual keyboard. The configuration may include linking or storing the sound effect file in a configuration file for the keyboard.

It will be appreciated that various of the methods described above may be combined to realize a device configured to perform keyboard theme customization based on a variety of types of inputs, including images, text, speech, music, etc., wherein the colour determination method may be partly dependent upon the type of media associated with the customization request or trigger.

Although many of the examples above describe the operations as being carried out by the computing device, certain operations may be at least partly carried out by another computing device, such a remote server. For example, certain image and/or audio generation operations reliant upon LLM modeling or other machine learning models may be partly performed by a remote server. In some cases, image, audio, or other media files may be obtained from a remote server.

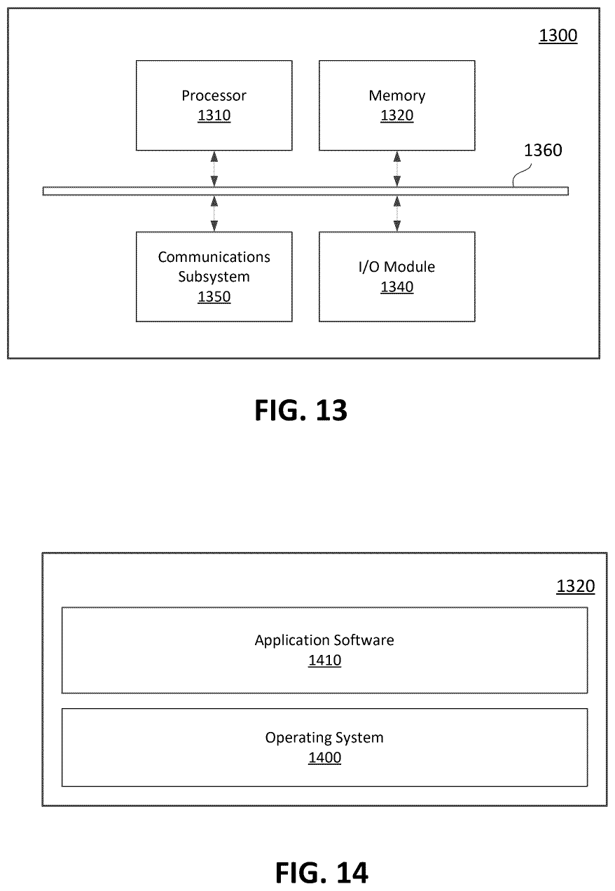

Reference will now be made to FIG. 13, which shows a high-level diagram of an example computing device 1300. The example computing device 1300 includes a variety of modules. For example, the example computing device 1300 may include a processor 1310, a memory 1320, an I/O module 1340, and a communications module 1350. As illustrated, the foregoing example modules of the example computing device 1300 are in communication over a bus 1360.

The processor 1310 in this example is a hardware processor. In some cases, the processor 1310 may include two or more processing units.

The memory 1320 allows data to be stored and retrieved. The memory 1320 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 1300.

The I/O module 1340 allows the example computing device 1300 to receive input signals and to transmit output signal. Input signals may, for example, correspond to input received from a user. Some output signals may, for example, allow provision of output to a user. The I/O module 1340 may serve to interconnect the example computing device 1300 with one or more input devices. Input devices may, for example, include one or more of a touchscreen input, keyboard, trackball or the like. The I/O module 1340 may serve to interconnect the example computing device 1300 with one or more output devices. Output devices may include, for example, one or more display screens such as, for example, a liquid crystal display (LCD). In embodiments in accordance with the present application, the output devices include at least on touchscreen display. Additional output devices may include devices other than screens such as, for example, a speaker, indicator lamps (such as, for example, light-emitting diodes (LEDs)), and printers.

The communications module 1350 allows the example computing device 1300 to communicate with other electronic devices and/or various communications networks. For example, the communications module 1350 may allow the example computing device 1300 to send or receive communications signals. As an example, the communication module 1350 may include a network connection, data port, or the like. Communications signals may be sent or received according to one or more protocols or according to one or more standards. For example, the communications module 1350 may allow the example computing device 1300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G, 6G, or the like. Additionally, or alternatively, the communications module 1350 may allow the example computing device 1300 to communicate using near-field communication (NFC), via Wi-Fi (™), via the Ethernet family of network protocols, using Bluetooth (™) or via some combination of one or more networks or protocols. In some embodiments, all or a portion of the communications module 1350 may be integrated into a component of the example computing device 1300. In some examples, the communications module may be integrated into a communications chipset.

Software instructions are executed by the processor 1310 from a computer-readable medium. For example, software may be loaded into random-access memory from persistent storage within memory 1320. Additionally, or alternatively, instructions may be executed by the processor 1310 directly from read-only memory of the memory 1320.

FIG. 14 depicts a simplified organization of software components stored in memory 1320 of the example computing device 1300. As illustrated, these software components include, at least, application software 1410 and an operating system 1400.

The application software 1410 adapts the example computing device 1300, in combination with the operating system 1400, to operate as a device performing a particular function. While a single application software 1410 is illustrated in FIG. 14, in operation, the memory 1320 may include more than one application software program and different application software programs may perform different operations.

The operating system 1400 is software. The operating system 1400 allows the application software 1410 to access the processor 1310, the memory 1320, the I/O module 1340, and the communications module 1350. The operating system 1400 may, for example, be iOS™, Android™, Linux™, Microsoft Windows™, or the like. Many of the operations, methods, or processes described herein may be implemented within the operating system 1400.

The application software 1410 and/or operating system 1400 may, when executed, cause the processor 1310 to carry out operations to implement at least some portion of one or more of the methods described herein.

In the present disclosure, the terms “a”, “an” and “one” are defined to mean “at least one”, that is, these terms do not exclude a plural number of items, unless stated otherwise.

In the present disclosure, terms such as “substantially”, “generally” and “about”, which modify a value, condition or characteristic of a feature of an embodiment, should be understood to mean that the value, condition or characteristic is defined within tolerances that are acceptable for the proper operation of this embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in embodiments of this application. “At least one” means one or more, and “a plurality of” means two or more. The term “and/or” describes an association relationship of associated objects and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements. The term “and/or” is intended to indicate that either of the two elements may be included or both of the elements may be included.

A person skilled in the art will understand that embodiments of this application may be provided as a method, an apparatus (or system), a computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It will be understood that a person skilled in the art may make various modifications and variations to this application without departing from the scope of this application. This application is intended to cover these modifications and variations of this application provided that they fall within the scope of protection defined by the following claims and their equivalent technologies.

Throughout the present disclosure, a processor, a processor system, an application processor, a baseband processor, a processor circuit, or a processor core may be collectively referred to as a processor. A processor may include one or more of a central processing unit (CPU), a digital signal processor (DSP), a microprocessor unit (MPU), a microcontroller unit, (MCU), a graphics processing unit (GPU), a field programmable gate array (FPGA), an artificial intelligence (AI) processor, or a neural network processing unit (NPU), or a combination of at least two of these integrated circuit forms.

Throughout the present disclosure, a memory may include one or more of the following storage media: a RAM, a static random access memory (SRAM), a dynamic random access memory (DRAM), a phase-change memory (PCM), a resistive random access memory (ReRAM), a magnetoresistive random access memory (MRAM), a ferroelectric random access memory (FRAM), a cache, a register, a read-only memory (ROM), a flash memory, an erasable programmable read-only memory (EPROM), a hard disk, and/or the like. In an example, the computer program instructions used to execute embodiments contained herein may be stored in a non-volatile memory. When a terminal runs, part or all of corresponding computer program instructions may be loaded into a memory that has a higher transmission speed with a corresponding processor, for example, the instructions may be loaded into at least a part of a memory such that the processor executes the computer program instructions to perform the steps in of embodiments described herein.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed:

1. A method of customizing a virtual keyboard on a computing device having a touchscreen, the method comprising:
detecting a virtual keyboard customization trigger associated with an image;
identifying, in a colour space, at least one dominant colour within the image;
determining a plurality of colours associated with the at least one dominant colour based on coordinates of the at least one dominant colour within the colour space through varying one or more dimensions of the coordinates within the colour space;
applying each of the plurality of colours to one or more respective keys of the virtual keyboard to generate a customized virtual keyboard; and
rendering the customized virtual keyboard on the touchscreen.

2. The method of claim 1, wherein varying one or more dimensions includes varying a dimension of the coordinates over a range, and wherein applying includes mapping the range of the dimension of the colour space to a dimension of the virtual keyboard.

3. The method of claim 2, wherein applying includes applying each of the plurality of colours to the one or more respective keys based on a position of that colour in the range being mapped to a corresponding position on a vertical or horizontal dimension of the virtual keyboard.

4. The method of claim 1, wherein detecting the virtual keyboard customization trigger includes detecting a drag-and-drop operation selecting the image and positioning at least a portion of the image atop the virtual keyboard.

5. The method of claim 4, wherein the detecting the drag-and-drop operation includes applying object segmentation to identify an object in the image, and wherein the identifying at least one dominant colour includes identifying the at least one dominant colour as a dominant colour within the object in the image.

6. The method of claim 5, wherein the drag-and-drop operation includes detecting selection and positioning of the object atop the virtual keyboard.

7. The method of claim 5, wherein identifying at least one dominant colour includes identifying a background dominant colour from the image excluding the object, and wherein applying includes applying the background dominant colour to a background region of the virtual keyboard surrounding the one or more respective keys of the virtual keyboard.

8. The method of claim 1, wherein identifying at least one dominant colour includes segmenting the image to identify an object of the image and identifying the at least one dominant colour within the object.

9. The method of claim 8, wherein segmenting includes identifying two or more objects and identifying a dominant colour associated with each of the two or more objects, and wherein determining the plurality of colours includes determining coordinates of each of the dominant colours and identifying the plurality of colours based on a gradient of colours that includes at least each of the dominant colours.

10. The method of claim 9, wherein the two or more objects are horizontally and vertically positioned relative to each other in the image, and wherein applying the plurality of colours includes mapping the plurality of colours to the one or more respective keys using a mapping based on the horizontal and vertical positioning of the two or more objects within the image.

11. The method of claim 1, wherein varying the one or more dimensions of the coordinates within the colour space includes varying one or more colour parameters of the dominant colour, wherein the colour parameters include one or more of hue, saturation, and brightness.

12. A method of customizing a virtual keyboard on a computing device having a touchscreen, the method comprising:
detecting a virtual keyboard customization trigger associated with a media item, wherein the media item has a media type selected from an image, text, or audio;
determining one or more characteristics of the media item;
mapping the one or more characteristics of the media item to at least one virtual keyboard feature in a different media type from the media item, wherein the virtual keyboard feature is one of a virtual keyboard colour, a key press sound effect, or a key press animation; and
applying the at least one virtual keyboard feature to a displayed virtual keyboard on the touchscreen.

13. The method of claim 12, wherein the media type of the media item is the text or the audio, and the audio is speech input, and wherein mapping includes converting the text or speech input to an image and selecting the virtual keyboard colour based on the image.

14. The method of claim 12, wherein the media type of the media item is the image and wherein determining includes performing object recognition within the image to identify an object, and wherein mapping includes selecting the key press sound effect based on the object.

15. The method of claim 12, wherein the media type of the media item is the audio, determining includes identifying one or more music characteristics from the audio, and wherein mapping includes determining one or more colours from the one or more music characteristics based on a music-colour model and wherein the at least one virtual keyboard feature is the one or more colours.

16. A method of customizing a virtual keyboard on a computing device having a touchscreen, the method comprising:
detecting a virtual keyboard customization trigger event;
in response to detecting the virtual keyboard customization trigger event, identifying an image;
determining two or more theme colours based on the image;
applying each of the two or more theme colours to one or more respective keys of the virtual keyboard to generate a customized virtual keyboard; and
rendering the customized virtual keyboard.

17. The method of claim 16, wherein detecting the virtual keyboard customization trigger event includes detecting a change in position of the virtual keyboard on a display screen having a background wallpaper image, and wherein identifying the image includes selecting a portion of the background wallpaper image over top of which the virtual keyboard is positioned as the image.

18. The method of claim 16, wherein detecting the virtual keyboard customization trigger event includes detecting selection of a new background wallpaper image for display on a display screen on which the virtual keyboard is rendered and wherein identifying an image includes selecting the new background wallpaper image as the image.

19. The method of claim 16, wherein detecting the virtual keyboard customization trigger event includes detecting a change in active application from a first application to a second application, and wherein identifying an image includes obtaining a screen shot image of the second application displayed on a display screen, and wherein determining two or more theme colours based on the image includes determining two or more theme colours based on the image and at least one configuration parameter for the second application.

20. The method of claim 16, wherein detecting the virtual keyboard customization trigger event includes detecting a game state change in a gaming application, and wherein identifying an image includes obtaining a screen shot image of the gaming application displayed on a display screen.
